(19) United States
(12) Patent Application Publication
(10) Pub. No.: US 2011/0129285 A1
(43) Pub. Date: Jun. 2, 2011

(54) RETRACTABLE PEN

(76) Inventor: Yu-Yin LIU, Taipei (TW)

(21) Appl. No.: 12/627,651

(22) Filed: Nov. 30, 2009

(51) Int. Cl. B43K 7/12

(52) U.S. Cl. 401/117

(57) ABSTRACT

A retractable pen includes an outer tube whose inner surface on a front end is arranged with a plurality of axial guiding rails circularly, an inner tube whose inner surface on a rear end is disposed with a plurality of stoppers is arranged circularly, a first sleeve mounted in the outer tube and having a plurality of ratchet teeth arranged circularly on a front end thereof as well as an axial guiding rail between two adjacent ratchet teeth sliding in the axial guiding rail of the outer tube, and an elastic member elastically supported between the front end of the inner tube and the axial guiding rail of the ring tube. In use, the rear end of the inner tube is pressed so as to change the length of the retractable pen.

### BACKGROUND OF THE INVENTION

The present invention to a retractable pen, especially to a retractable pen in which a refill extends from an outer tube to be a writing state and the length of the pen is also longer.

Generally a pen includes a retractable refill, a pen holder and a button. When the button is pressed down toward a pen head (writing end), the refill is extended from the pen holder is ready to write. When the button is pressed again to be released, the refill is retracted back to the pen holder. The pen with shorter length is easy to carry and put in the pocket or purses. Moreover, the length of some pens is adjustable so as to be used in combination with other things such as notebooks for easy carrying. Thus there is a design of retractable pen holder as shown in U.S. Pat. No. 3,174,461. However, the pen refill is unable to retract into the pen holder so that it would stain the clothes. Refer to U.S. Pat. No. 3,709,620, although the refill can retract into the pen holder, the disposition of the components is more complicated. Moreover, the member that retracts the refill is not worked along with the pen holder. Once the pen holder is extended, the refill is not extended simultaneously. Refer to U.S. Pat. No. 6,832,868, the structure of the control unit is complicated and more components are required. This is not suitable for mass production of small-size pens.

### SUMMARY OF THE INVENTION

Therefore it is a primary object of the present invention to provide a retractable pens that includes an outer tube, an inner tube, a first sleeve, a second sleeve, an elastic member and a refill. An inner surface of a front end of the outer tube is arranged with a plurality of axial guiding rails. The inner tube is disposed in the outer tube and its rear end thereof extends from the rear end of the outer tube while a plurality of stoppers is arranged circularly on an inner surface of the inner tube, and a location block is arranged at an inner surface on a front end of the inner tube. The first sleeve is mounted into the outer tube and an outer surface of the front end of the first sleeve is arranged with a plurality of ratchet teeth circularly and an axial guiding slot is disposed between the two adjacent ratchet teeth so as to slide into the axial guiding rail of the outer tube. The outer surface of the first sleeve is disposed with an axial location slot so that the location block on the inner tube can slide between a front end and a rear end of the axial location slot. The second sleeve is partially sleeved in the first sleeve and its front end is arranged with a plurality of ratchet teeth circularly and an axial guiding slot is disposed between the two adjacent ratchet teeth so as to slide into the axial guiding rail of the outer tube. At least one fastener is disposed on a rear end of the second sleeve, projecting from the rear end of the first sleeve and corresponding to the stopper of the inner tube. Two ends of the elastic member arranged in the outer tube respectively are against the front end of the inner tube and the rear end of the axial guiding rail of the outer tube. The refill is mounted into the front end of the second sleeve. Thereby the retractable pen can switch between long and short forms.

It is another object of the present invention to provide a retractable pen in which a ring tube is arranged on the inner surface of the front end of the outer tube while the ring tube is disposed with a plurality of axial guiding rails arranged circularly corresponding to the axial guiding slots of the first sleeve as well as the second sleeve. Moreover, the elastic member is elastically supported between the front end of the inner tube and the rear end of the ring tube for being beneficial for designing and production of components performance.

It is another object of the present invention to provide a retractable pen that is pressed continuously multiple times by a single hand of users so as to make the length of the pen switch between long and short forms, thereby enhancing the convenience of operation.

### BRIEF DESCRIPTION OF THE DRAWINGS

FIG. 1 is a perspective view of an embodiment of a retractable pen in a retracted state according to the present invention;

FIG. 2 is a perspective view of an embodiment of a retractable pen in a writing state according to the present invention;

FIG. 3 is an explosive view of an embodiment of a retractable pen according to the present invention;

FIG. 4 is a partial cross sectional view of the embodiment in FIG. 1;

FIG. 5 is a partial cross sectional view of the embodiment in FIG. 2;

FIG. 6 is a partial cross sectional view of an embodiment of a retractable pen with a pen clip disposed on an outer sleeve according to the present invention;

FIG. 7 is a partial cross sectional view of is a partial cross sectional view of an embodiment of a retractable pen with a pen clip disposed on an outer tube according to the present invention;

FIG. 8 is a partial cross sectional view of is a partial cross sectional view of an embodiment of a retractable pen with a pen clip disposed on an inner tube according to the present invention.

### DETAILED DESCRIPTION OF THE PREFERRED EMBODIMENT

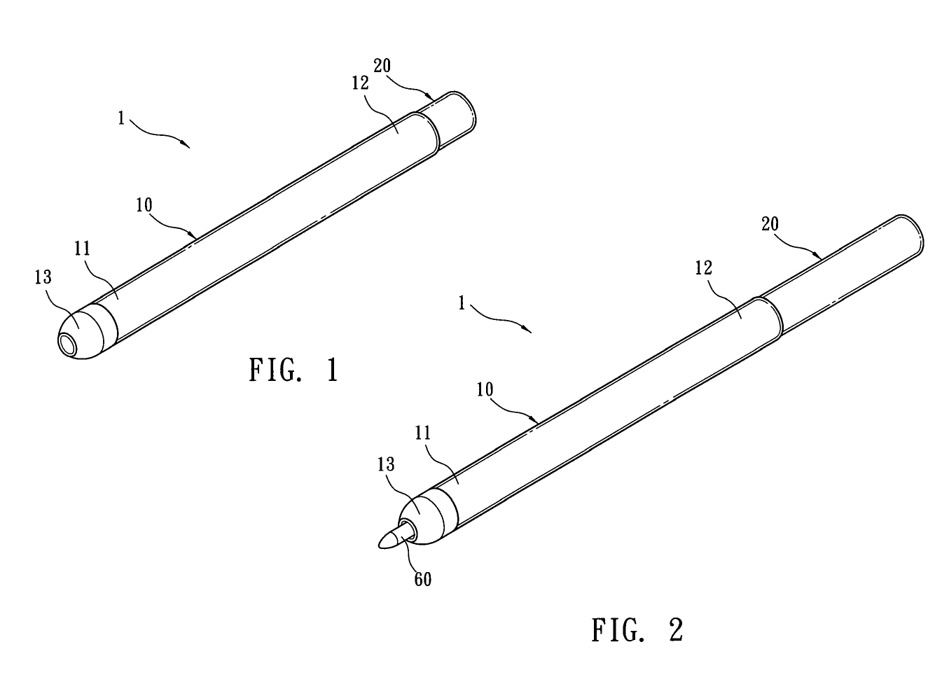

Refer from FIG. 1 to FIG. 3, a retractable pen 1 of the present invention includes an outer tube 10, an inner tube 20, a first sleeve 30, a second sleeve 40, an elastic member 50 and a refill 60. The outer tube 10 includes a front end 11 and a rear end 12. The front end 11 is sleeved with a pen head 13 and an inner surface of the outer tube 10 is arranged with a plurality of axial guiding rails 15 at an equal distance. A front end of each guiding rail 15 is designed into a bevel so as to slide correspondingly in each axial guiding slot 32, 42 disposed on the first sleeve 30 and the second sleeve 40 respectively. The axial guiding rails 15 can also be disposed on a ring tube 14 that is mounted on an inner surface of the front end 11. Moreover, the ring tube 14 can be integrated with the outer tube 10.

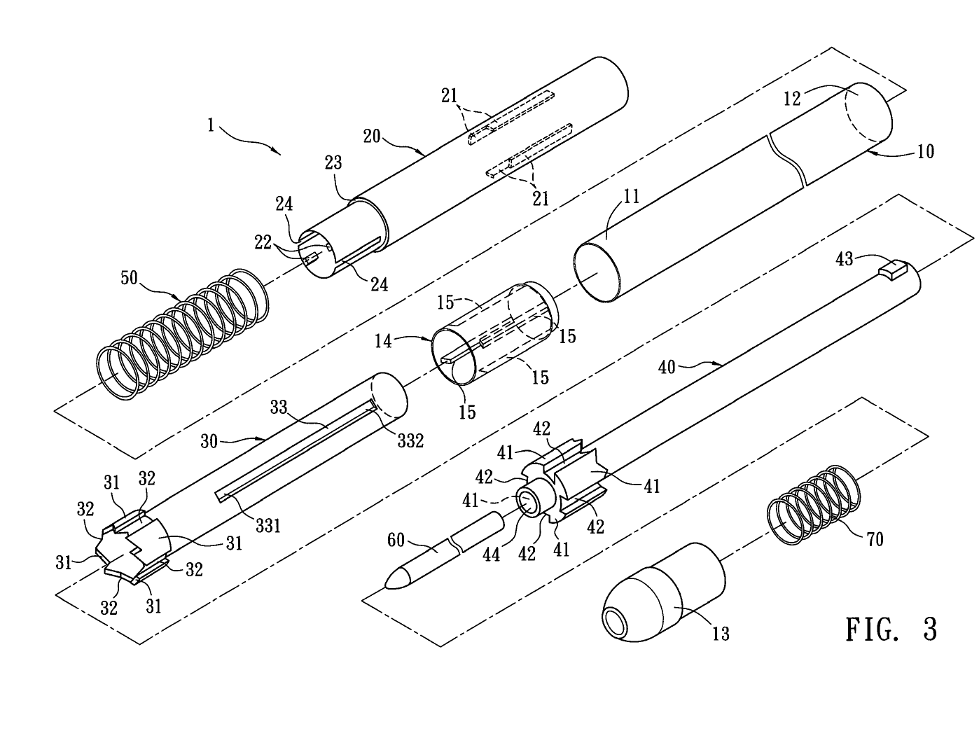

The inner tube 20 is inserted into the outer tube 10 through the rear end 12 thereof and is sliding in the outer tube 10. The rear end of the inner tube 20 projects from the rear end 12 of the outer tube 10 and a plurality of stoppers 21 is arranged circularly at a certain distance on an inner surface of the inner tube 20. As shown in FIG. 3, there are four stopper 21, but not limited to this number. A location block 22 is arranged at an inner surface on the front end of the inner tube 20 while a shoulder part 23 is formed on an outer surface of the inner tube 20. The front end of the inner tube 20 is further disposed with at least opening 24 so as to assemble with the first sleeve 30.

The first sleeve 30 is mounted from a front end of the outer tube 10 and is sleeved movably in the inner tube 20. An outer surface of the front end of the first sleeve 30 is arranged circularly with a plurality of ratchet teeth 31 at an equal distance and an axial guiding slot 32 is disposed between the two adjacent ratchet teeth 31. As shown in FIG. 3, there are, but not limited to, four ratchet teeth 31 and four axial guiding slots 32. An axial location slot 33 is arranged at an outer surface of the first sleeve 30 so that the location block 22 on the inner tube 20 can slide between a front end 331 and a rear end 332 of the axial location slot 33.

The second sleeve 40 is partially sleeved in the first sleeve 30 and a plurality of ratchet teeth 41 is arranged circularly at an equal distance on an outer surface of the front end thereof while an axial guiding slot 42 is disposed between the two adjacent ratchet teeth 41, corresponding to the ratchet teeth 31 and the axial guiding slot 32 of the first sleeve 30. As shown in figure, there are, not limited to, four ratchet teeth 41 and four axial guiding slots 42. The axial guiding slot 42 slides in the axial guiding rail 15 of the outer tube 10. At least one fastener 43 is disposed on a rear end of the second sleeve 40 and is projecting from the rear end of the first sleeve 30 so as to correspond to the stopper 21 on the inner surface of the inner tube 20. Moreover, a receiving slot 44 for receiving the refill 60 is disposed on a front end of the second sleeve 40. A compression spring 70 is further arranged between the front end of the second sleeve 40 and the pen head 13 of the outer tube 10.

The elastic member 50 elastically supported between the shoulder part 23 of the inner tube 20 and the rear end of the axial guiding rail 15 of the outer tube 10 is a compression spring that moves between the front end of the inner tube 20 and the rear end of the guiding rail 15.

The refill 60 is mounted into the receiving slot 44 on the front end of the second sleeve 40. The refill 60 is not limited. It can be a pencil refill, a pen, a ball-pen refill, a personal digital assistance (PDA) refill, etc.

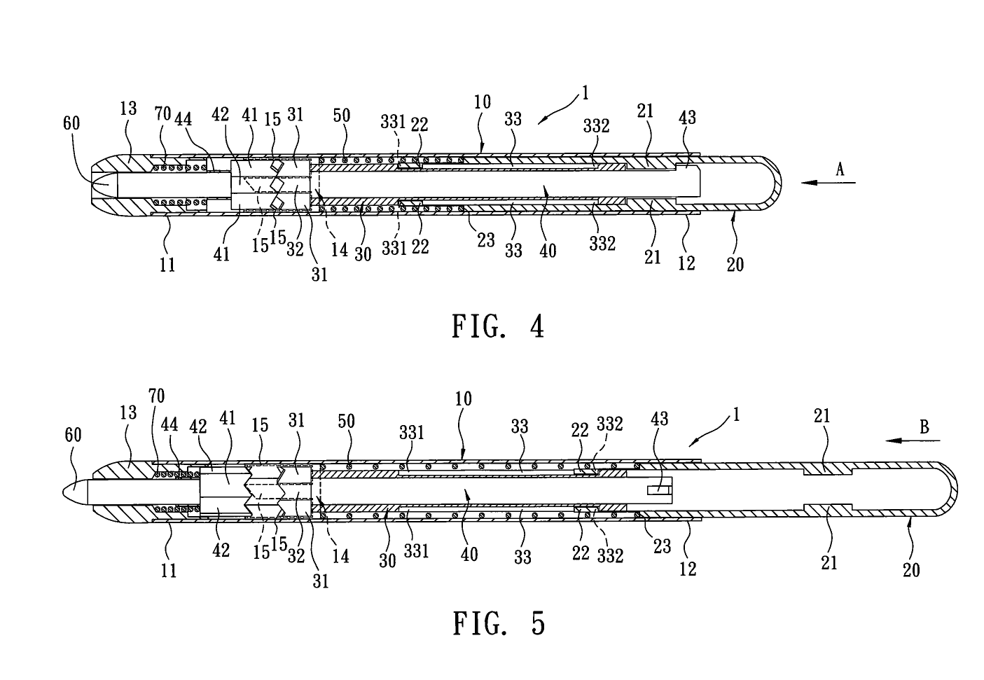

Refer to FIG. 4, when the rear end of the inner tube 20 is pressed, as the arrow A indicates, to make the retractable pen 1 become a short state (retracted state), the outer tube 10 and the ring tube 14 remain in place while the ratchet teeth 41 rotates around and moves to the ratchet teeth 31 so that the second sleeve 40 moves into the first sleeve 30 and the two axial guiding slots 32, 42 connect with each other and slide into the axial guiding rail 15 of the ring tube 14, unable to rotate and turn back. Now the fastener 43 of the second sleeve 40 is locked with the stopper 21 of the inner tube 20. At the same time, the elastic member 50 is compressed and the location block 22 on the inner tube 20 moves to the front end 331 of the location slot 33 of the first sleeve 30. The refill 60 retracts into the pen head 13 along with the movement of the second sleeve 40.

Refer to FIG. 5, when the rear end of the inner tube 20 is pressed, as the arrow B indicates, to make the retractable pen 1 become a long state (writing state), the outer tube 10 and the ring tube 14 remain in place while the ratchet teeth 41 rotates around and moves toward the ratchet teeth 31 so as to make the fastener 43 of the second sleeve 40 release from the stopper 21 of the inner tube 20 and the second sleeve 40 moves out of the first sleeve 30. The tooth ends of the ratchet teeth 41 are locked and fixed in the front end of the axial guiding rail 15, unable to rotate and turn back. The elastic member 50 is extended while the inner tube 20 is extended to a position that is a certain distance away from the rear end 12 of the outer tube 10. The distance is about equal to the length between the front end 331 and the rear end 332 of the location slot 33. Now the location block 22 on the inner tube 20 moves from the front end 331 of the location slot 33 of the first sleeve 30 to be locked with the rear end 332 of the location slot 33. The refill 60 extends from the pen head 13 along with the movement of the second sleeve 40.

Refer to FIG. 6, the retractable pen 1 further includes an outer sleeve 80 that is sleeved with the rear end 12 of the outer tube 10 slidingly and movably and the inner tube 20 is received in the outer sleeve 80 and is moved synchronously with the outer sleeve 80.

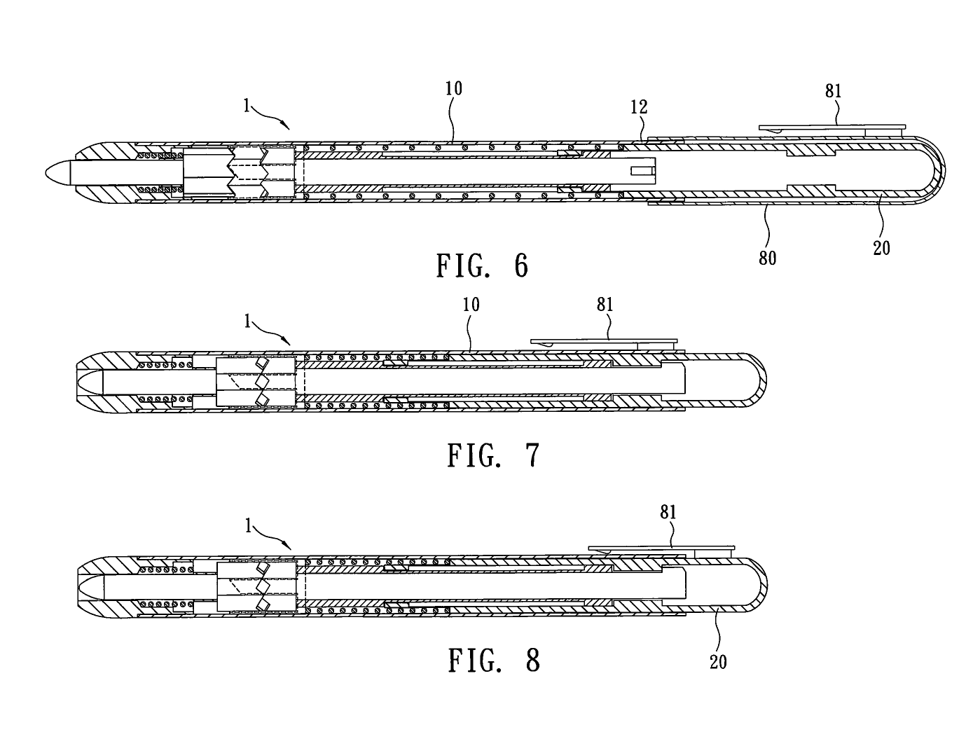

Refer from FIG. 6 to FIG. 8, the retractable pen 1 is further disposed with a pen clip 81. The pen clip 81 is arranged at the outer sleeve 80, as shown in FIG. 6. It can be set on the outer tube 10, as shown in FIG. 7 or on the inner tube 20, as shown in FIG. 8.

In use, by pressing the inner tube 20, the corresponding ratchet teeth 31, 41 of the first sleeve and the second sleeve 30, 40 can rotate around and move toward each other so as to make the retractable pen 1 switch between two modes—the extended (writing) state and the compressed (retracted) state. Therefore, the retractable pen 1 is portable and easy to operate.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A retractable pen comprising:
an outer tube in which a plurality of axial guiding rails arranged circularly is disposed on an inner surface of a front end thereof;
an inner tube mounted in the outer tube having a rear end thereof extending from a rear end of the outer tube, a plurality of stoppers arranged circularly on an inner surface thereof, and at least one location block disposed at an inner surface on a front end thereof;
a first sleeve that is mounted into the outer tube and having a plurality of ratchet teeth arranged circularly on an outer surface of a front end thereof, an axial guiding slot disposed between the two adjacent ratchet teeth and connecting slidingly with the axial guiding rail of the outer tube, and an axial location slot on an outer surface thereof for the location block of the inner tube sliding between a front end and a rear end of the axial location slot;
a second sleeve that is partially sleeved in the first sleeve and having a plurality of ratchet teeth arranged circularly on an outer surface of a front end thereof, an axial guiding slot disposed between the two adjacent ratchet teeth, corresponding to the ratchet teeth and the axial guiding slot of the first sleeve, and at least one fastener disposed on a rear end thereof, projecting from the rear end of the first sleeve and corresponding to the stopper of the inner tube; the axial guiding slot thereof sliding in the axial guiding rail of the outer tube;
an elastic member that is elastically supported between the front end of the inner tube and the rear end of the axial guiding rail of the outer tube; and
a refill sleeved with the front end of the second sleeve;
wherein when the rear end of the inner tube is pressed to drive the second sleeve rotating and moving, the axial guiding rail of the second sleeve slides into the axial guiding rail and the ratchet teeth of the second sleeve locks with the ratchet teeth of the first sleeve to drive the refill retracting into the outer tube; the fastener of the second sleeve is locked with the stopper of the inner tube and the elastic member is compressed so that the rear end of the inner tube extends from and keeps a short distance with the rear end of the outer tube while the location block of the inner tube is stopped by the front end of the location slot of the first sleeve so that the retractable pen is shortened to be in a retracted state; when the rear end of the inner tube is pressed again, the second sleeve rotates and moves axially relative to the first sleeve so that the axial guiding slot of the second sleeve slides out of the axial guiding rail and tooth ends of the ratchet teeth of the second sleeve are locked and fixed in the front end of the axial guiding rail so that the refill is extended from the front end of the outer tube; now the fastener of the second sleeve is released from the stopper of the inner tube and the elastic member is extended to make the inner tube move backward and extend from the rear end of the outer tube while the location block of the inner tube is locked with the rear end of the location slot of the first sleeve so that the retractable pen is extended to be in a writing state.

2. The device as claimed in claim 1, wherein the plurality of axial guiding rails arranged circularly on the outer tube is set on a ring tube that is arranged on the inner surface of the front end of the outer tube.

3. The device as claimed in claim 1, wherein a shoulder part is formed on an outer surface of the front end of the inner tube so that the elastic member is elastically supported between the shoulder part of the inner tube and the rear end of the axial guiding rail of the outer tube.

4. The device as claimed in claim 1, wherein the plurality of axial guiding rails of the outer tube, the ratchet teeth and axial guiding slots of the first sleeve, and the ratchet teeth and axial guiding slots of the second sleeve are all arranged at an equal distance and correspondingly.

5. The device as claimed in claim 1, wherein the first sleeve and the second sleeve respectively are arranged with four ratchet teeth and four axial guiding slots.

6. The device as claimed in claim 1, wherein a receiving slot for receiving the refill is disposed on the front end of the second sleeve.

7. The device as claimed in claim 1, wherein a pen head is disposed on the front end of the outer tube and a compression spring is arranged between the pen head and the front end of the second sleeve.

8. The device as claimed in claim 1, wherein a pen clip is disposed on the outer tube or the inner tube.

9. The device as claimed in claim 1, wherein the retractable pen further includes an outer sleeve that is sleeved with the rear end of the outer tube slidingly and moving along with the inner tube synchronously.

10. The device as claimed in claim 1, wherein the outer sleeve is disposed with a pen clip.
